(19) United States
(12) Patent Application Publication
(10) Pub. No.: US 2026/0001482 A1
(43) Pub. Date: Jan. 1, 2026

(54) VEHICULAR SENSING SYSTEM

(71) Applicant: Magna Electronics Inc., Auburn Hills, MI (US)

(72) Inventor: Michael Hartmut Weidmann, Alzenau (DE)

(21) Appl. No.: 19/248,734

(22) Filed: Jun. 25, 2025

Related U.S. Application Data
(60) Provisional application No. 63/664,826, filed on Jun. 27, 2024.

(51) Int. Cl. B60Q 9/00; B60L 53/16; B60Q 1/30; B60Q 1/44; B60R 13/10

(52) U.S. Cl. CPC B60Q 9/00; B60L 53/16; B60Q 1/30; B60Q 1/302; B60Q 1/44; B60R 13/105

(57) ABSTRACT

A vehicular sensing system includes an electronic control unit (ECU) disposed at a vehicle and having electronic circuitry and associated software. A sensor is disposed at the vehicle. The vehicular sensing system is operable, at least in part via processing at the ECU of sensor data captured by the sensor, to determine whether a license plate is mounted at a license plate mounting region of the vehicle. Responsive to determining, at least in part via processing at the ECU of sensor data captured by the sensor, that no license plate is mounted at the license plate mounting region, the vehicular sensing system generates an alert for a driver of the vehicle.

### CROSS REFERENCE TO RELATED APPLICATION

The present application claims the filing benefits of U.S. provisional application Ser. No. 63/664,826, filed Jun. 27, 2024, which is hereby incorporated herein by reference in its entirety.

### FIELD OF THE INVENTION

The present invention relates generally to a vehicular sensing system for a vehicle and, more particularly, to a vehicular sensing system that alerts a driver based on a sensed condition of the vehicle.

### BACKGROUND OF THE INVENTION

It is known to provide an alert system at a vehicle that displays messages, illuminates icons, or plays audio tones to, for example, notify a driver of the vehicle of required vehicle maintenance or to prompt the driver to put on a seatbelt.

### SUMMARY OF THE INVENTION

A sensing system or alert system for a vehicle may determine whether a license plate or registration plate is affixed to the vehicle and, based on determining that the license plate is affixed to the vehicle, permit the vehicle to be operated. Based on determining that no license plate is affixed to the vehicle, the system may alert the driver that a license plate is not properly disposed at the vehicle and/or prevent the vehicle from being operated (e.g., by disabling an ignition system or propulsion system of the vehicle). Optionally, the system may determine whether a charge port or fuel port cover panel is closed or opened, and based on determining that the cover panel is closed, permit the vehicle to be operated. Based on determining that the cover panel is opened, the system may alert the driver and/or prevent the vehicle from being operated. Optionally, the system may operate backlights or rear running lights of the vehicle based on a determined environmental condition, such as based on sensing rain or based on sensing that ambient light levels at the vehicle are below a threshold level of ambient light.

For example, a vehicular sensing system includes an electronic control unit (ECU) disposed at the vehicle. The ECU includes electronic circuitry (e.g., a data processor and/or an image data processor) and associated software. A sensor is disposed at the vehicle. The sensor views or senses a license plate mounting region of the vehicle, and the license plate mounting region is configured to mountably receive a license plate. The vehicular sensing system, based on processing at the ECU of sensor data captured by the sensor, determines presence of the license plate at the license plate mounting region. Based on determination that no license plate is present at the license plate mounting region, the vehicular sensing system generates an alert for a driver of the vehicle.

These and other objects, advantages, purposes and features of the present invention will become apparent upon review of the following specification in conjunction with the drawings.

### BRIEF DESCRIPTION OF THE DRAWINGS

FIG. 1 is a rear perspective view of a vehicle with a vehicular sensing system.

### DESCRIPTION OF THE PREFERRED EMBODIMENTS

A vehicular sensing system or alert system and/or driver or driving assist system operates to capture sensor data exterior of the vehicle and may process the captured sensor data to determine a vehicle condition and/or an environmental condition. For example, the vehicular sensing system may determine whether a license plate or registration plate is disposed at the vehicle and the system may generate an alert to the driver and/or prevent or preclude operation of the vehicle based on determination that no license plate is properly disposed at the vehicle. Optionally, the vehicular sensing system may determine whether a fuel port or charge port cover panel is in a closed position or an opened position and the system may generate an alert to the driver and/or prevent or preclude operation of the vehicle based on determination that the cover panel is in the opened position. Further, the vehicular sensing system may operate rear lights of the vehicle based on sensing rain and/or determining that ambient light levels at the vehicle are below a threshold ambient light level.

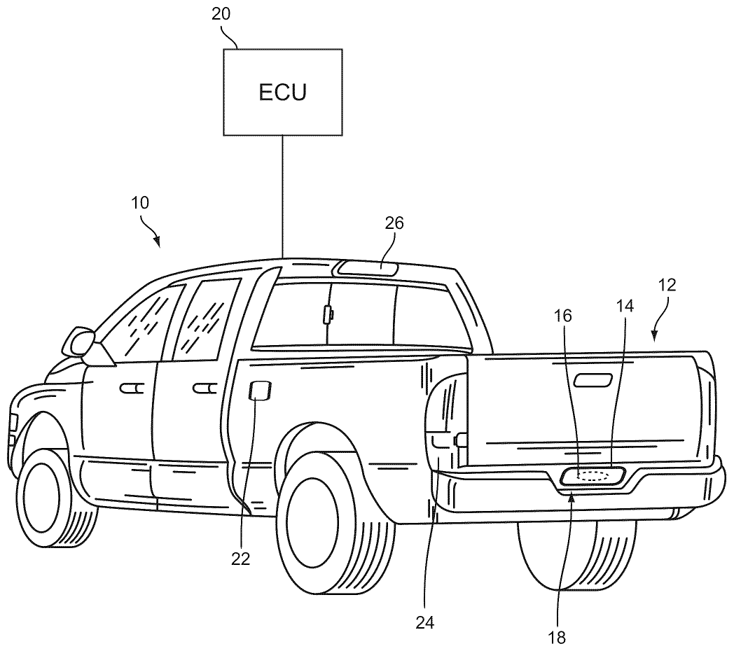

Referring now to the drawings and the illustrative embodiments depicted therein, a vehicle 10 is equipped with a sensing system or alert system 12 that is operable to determine whether a license plate or number plate or registration tag 14 is properly mounted to the vehicle 10 (FIG. 1). The system 12 includes one or more sensors 16 disposed at or near a license plate mounting region 18 of the vehicle 10. The license plate mounting region 18 includes a portion of the vehicle 10 configured to mountably receive the license plate 14 and/or a bracket disposed at the vehicle 10 and configured to receive the license plate 14, such as at a portion of a rear bumper or front bumper of the vehicle, at a portion of a tailgate or liftgate or trunk of the vehicle, and the like. The license plate 14 may be fixedly attached to the vehicle 10, such as via threaded fasteners, or removably attached to the vehicle 10, such as via magnetic attachment.

Based on signals from or sensor data captured by the sensor 16, the system 12 may be operable to determine whether the license plate 14 is disposed at the license plate mounting region 18. For example, the sensor 16 may be disposed at the license plate mounting region 18, such that the sensor 16 is disposed behind or at least partially covered by the license plate 14 when the license plate 14 is disposed at the vehicle 10, and the system 12 detects whether the license plate 14 is disposed at the mounting region 18 based on whether the sensor 16 is covered by an object. The sensor 16 may include a proximity sensor (e.g., an inductive sensor, a capacitive sensor, a photoelectric sensor, a radar sensor, and the like) operable to sense objects within a field of sensing of the sensor, a contact sensor operable to sense objects contacting at least a portion of the sensor or at least a portion of the vehicle at or near the license plate mounting region 18, a pressure sensor operable to sense objects applying a pressure to at least a portion of the sensor or at least a portion of the vehicle at or near the license plate mounting region, an imaging sensor or camera, a light sensor or time-of-flight sensor or any suitable sensor for determining presence or lack of presence of the license plate 14.

Responsive to sensing the license plate 14 at the mounting region 18, the sensor 16 transmits a signal to an electronic control unit (ECU) 20 of the vehicle that is indicative of the license plate 14 being present at the vehicle 10. Optionally, the sensor 16 may communicate captured sensor data to the ECU 20 and a data processor at the ECU 20 may process the captured sensor data for determining presence of the license plate 14 at the vehicle 10. For example, the system may determine that the license plate 14 is present at the license plate mounting region 18 based on the proximity sensor sensing an object within at least a threshold distance of the sensor and/or license plate mounting region 18 (e.g., within 3 inches or less, within 1 inch or less, within 0.5 inches or less, and the like). The proximity sensor may transmit a signal to the ECU 20 indicative of the object being within the threshold distance or the proximity sensor may transmit sensor data representative of the distance between the proximity sensor and the sensed object.

Further, the contact sensor may transmit a signal or sensor data to the ECU 20 indicating that an object is contacting the contact sensor, and the system 12 may determine that the license plate 14 is present at the license plate mounting region 18 responsive to the signal or sensor data from the contact sensor. In other words, sensor data from the contact sensor may comprise a signal indicating that the contact sensor or switch is engaged or depressed. Similarly, the pressure sensor may transmit a signal or sensor data to the ECU 20 indicating that an object is applying pressure at the pressure sensor. The signal may indicate that the object is applying greater than a threshold level of pressure and the system 12 may determine presence of the license plate 14 responsive to receiving the signal. Optionally, the pressure sensor may transmit sensor data representative of a level of pressure applied to the pressure sensor and the system 12 may determine presence of the license plate 14 at the license plate mounting region 18 based on the sensor data indicating that the threshold level of pressure is applied at the pressure sensor.

Further, the system 12 may be configured to determine whether the license plate 14 is properly mounted to the vehicle 10. For example, based on processing sensor data captured by the sensor 16 that is representative of a pressure applied by the license plate 14 at the sensor 16, the system 12 may determine that the license plate 14 is loosely attached to the vehicle 10.

Optionally, the license plate 14 may include a short-range wireless communication device, such as a radio frequency identification (RFID) or near-field communication (NFC) chip or tag, that is configured to broadcast a signal or identifier associated with the license plate 14. For example, the signal may be representative of a registration number associated with the license plate 14. The sensor 16 at the vehicle may be configured to communicate with the short-range wireless communication device at the license plate 14 for determining whether the license plate 14 at the vehicle 10 is associated with the vehicle 10 and/or whether registration for the vehicle is valid and up to date. In other words, based on signals communicated between the sensor 16 and the license plate 14, the system 12 may determine whether the license plate 14 is associated with the vehicle 10. The ECU 20 may be in wireless communication with a remote server (e.g., a government database) for determining whether the registration number of the license plate 14 is associated with the vehicle 10 and/or valid or up to date. Optionally, the ECU 20 may store in memory one or more license plate identities authorized for use with the vehicle 10.

Optionally, more than one license plate 14 may be authorized for use with the vehicle 10. For example, a car dealership or rental car company or other fleet vehicle service may manage multiple license plates 14 that can be exchanged between different vehicles. Accordingly, based on the identification signal received from the license plate 14, the ECU 20 may determine whether the license plate 14 is one of a plurality of license plates authorized for use with the vehicle 10. Optionally, the sensor may comprise a camera or imaging sensor that captures image data that is processed to determine presence of the license plate and to determine the license plate number for determining whether the license plate is associated with or authorized for that vehicle.

Based on determination that no license plate 14 is present at the mounting region 18 or based on determination that the license plate 14 is improperly mounted to the vehicle 10 (and optionally based on determination that the license plate present at the mounting region is not authorized for use with the vehicle), the system 12 may generate an alert to the driver of the vehicle. For example, the alert may include an audio tone or message played within the interior cabin of the vehicle, a visual alert icon illuminated at the gauge cluster or dashboard of the vehicle, a message displayed at the infotainment system of the vehicle 10, a message (e.g., text message) communicated to the authorized user's smartphone and/or the like. Optionally, the system 12 may prevent or preclude the driver from operating the vehicle when no license plate is present at the vehicle 10, such as by preventing the engine or propulsion system from starting or operating, preventing the transmission from shifting out of a parking gear, and the like. Based on determination that the license plate 14 is disposed at the vehicle 10 (and optionally based on determination that the license plate 14 is authorized for use with the vehicle 10), the vehicle 10 may be operated normally.

Thus, the system 12 may ensure that the vehicle 10 is operated with a license plate 14 properly mounted at a designated mounting region 18. For example, the system 12 may be operable to detect presence of the license plate 14 only when the license plate is properly oriented relative to the vehicle (e.g., in a horizontal configuration) and sufficiently attached to the vehicle (e.g., the sensor may sense presence of the license plate only when the license plate is securely attached rather than loosely attached). Moreover, the system 12 may ensure that the license plate 14 disposed at the vehicle 10 is valid and associated with the vehicle 10.

In other words, the system may recognize if a legally matching number plate is mounted to the vehicle. The system may be realized by a sensor disposed behind the plate to recognize whether or not a number plate is mounted at the vehicle. The system may further include a short-range wireless reader at the vehicle for detecting and/or reading or communicating with a short-range wireless chip of the number plate, such as utilizing radio frequency identification (RFID) or near-field communication (NFC) protocols, to only allow a legally matching number plate on the vehicle. If no legally matching number plate is attached to the vehicle, the system may prevent the engine or propulsion system from starting and/or prevent the driver from operating the vehicle.

The system includes a sensor to sense whether or not the number plate is mounted to the vehicle and the number plate may be locked to the vehicle by an NFC or RFID tag. The signal from the sensor is sent to the ECU of the vehicle, which processes the signal from the sensor to determine whether the number plate is mounted to the vehicle and/or whether the mounted plate is legally matched to the vehicle and/or whether the registration for that license plate and vehicle has been renewed. Based on determination at the ECU that no license plate is mounted or that the license plate does not correspond to the vehicle, the system may prevent the engine or propulsion system from starting and/or the system may generate an alert to the driver (e.g., illuminate a warning indication lamp at the gauge cluster or dashboard).

Thus, the driver may mount the number plate to the vehicle in a standard fashion as the detection of the license plate (e.g., via proximity sensor and/or RFID/NFC tag) is completed without wired connection to the license plate. Vehicles equipped with the system may not be driven without a legally matching number plate. This may increase security and safety and result in less crime and/or easier crime detection. Further, this may result in fewer penalties (e.g., a fine for driving without a valid registration tag) as the driver may receive a notification of expired registration and/or may not be able to drive the vehicle without a number plate and/or with a non-matching number plate.

Further, the vehicle 10 may be an electrically powered vehicle having a power charge flap or panel 22 that covers a charging connector configured to electrically connect with an electrical connector of a charging wand to charge batteries of the electrically powered vehicle. Aspects of the power charge flap described herein may also be suitable for use with a fuel port cover for covering a fuel filler port or opening of a vehicle that is configured to receive a nozzle that delivers fuel (e.g., gasoline) to a fuel tank of the vehicle via the fuel port.

For example, the panel 22 is mounted at the vehicle and has an outer surface that, when the panel 22 is in a closed position (FIG. 1), corresponds with and/or is substantially flush with an outer surface of the exterior panel(s) of the vehicle 10 at and around the charge port of the vehicle. When in the closed position, the cover panel 22 conceals a charging connector of the charge port that is configured or operable to electrically connect with an electrical connector or charging wand of a charging station or system to charge batteries of the vehicle 10. When in an open position, the cover panel 22 moves at least partially away from the body panel along the side of the vehicle 10 to reveal the charging connector such that the electrical connector of the charging wand (that is electrically connected to the charging station or system and that is configured or operable for electrically connecting to or plugging into the charging connector of the vehicle) can electrically connect to the charging connector.

As shown, the charge port is disposed along a side of the vehicle 10 and, when the cover panel 22 is in the closed position, the exterior surface of the panel 22 is substantially flush with and corresponds to the exterior surface of the vehicle 10. The charge port may be disposed at any suitable position at the exterior of the vehicle. For example, the charge port may be disposed at the front or rear fender or bumper of the vehicle. Optionally, the charge port may be concealed behind an exterior feature of the vehicle 10, such as a manufacturers emblem, a portion of a headlight or taillight, a license plate bracket, or the like.

The cover panel 22 may be movable between the closed position and the opened position via operation of an electrically operable actuator. The cover panel 22 and actuator may utilize characteristics of the charge ports and charging systems described in U.S. Publication Nos. US-2025-0115144; US-2024-0328229; US-2024-0294077; US-2024- 0246409; US-2023-0191926 and/or US-2024-0109409, which are hereby incorporated herein by reference in their entireties.

A sensor may be disposed at or near the cover panel 22 for determining whether the cover panel 22 is in the opened or closed position. For example, the sensor may be disposed at the charge port and configured to contact an inner surface of the cover panel 22 when the cover panel is moved to the closed position. Optionally, the sensor may include an encoder at the actuator for determining whether the cover panel 22 is in the closed position or the opened position. That is, the actuator may include an electrically operable motor and an encoder that tracks a rotational position and/or speed of the motor for tracking a position of the cover panel 22 between the closed position and the opened position. The sensor may transmit a signal to the ECU 20 indicative of the cover panel 22 being in the opened or closed position. Optionally, sensor data captured by the sensor is transmitted to the ECU 20 and processed at the ECU for determining position of the cover panel 22.

Based on determination that the cover panel 22 is in the opened position, the system 12 may generate an alert to the driver. For example, the alert may include an audio tone or message played within the interior cabin of the vehicle, an alert icon illuminated at the gauge cluster or dashboard of the vehicle, a message displayed at the infotainment system of the vehicle 10, and the like. The alert may be generated if the driver attempts to operate the vehicle (e.g., turn on the vehicle and/or place the vehicle in a driving gear or propulsion mode) with the cover panel 22 in the opened position. Optionally, the system 12 may prevent or preclude the driver from operating the vehicle when the cover panel 22 is in the opened position, such as by preventing the engine or propulsion system from starting or operating, preventing the transmission from shifting out of a parking gear, and the like. Based on determination that the cover panel 22 is in the closed position, the vehicle 10 may be operated normally.

Optionally, based on determination that the cover panel 22 is in the opened position, and based on determination that the driver has forgotten to close the cover panel 22 (e.g., based on the driver attempting to start the vehicle, based on the driver opening the door and entering the vehicle, based on determination that the charging connector has been disconnected from the charge port, and the like), the system 12 may operate the actuator to move the cover panel 22 to the closed position. For example, based on determination that the cover panel 22 is in the opened position, the system 12 may close the cover panel 22 in response to the driver starting the vehicle. Thus, the system 12 may prevent or preclude or warn the driver from operating the vehicle 10 with the cover panel 22 in the opened position.

In other words, the system may provide automatic fuel cap recognition or charging socket cap recognition and/or automatic fuel cap closing or charging socket cap closing. The system may detect if the fuel cap or charging socket cap is still open following refueling or recharging. The system may prevent the engine or propulsion system from starting or operating and/or the system may prevent the propulsion system from shifting into a drive mode when the fuel cap or charging socket cap is still open. Further, the system may close the opened cap when the propulsion system (e.g., engine or electric motor) is started. The system may include a sensor to detect if the fuel cap or charging socket cap is closed or not and transfers this signal to the ECU. Further, the system may operate an actuator connected to the cap for automatically closing the cap.

Thus, if the fuel cap or charging socket cap is still open after filling up the fuel tank or charging the battery of the vehicle, the propulsion system may not start and/or an indication lamp at the gauge cluster or dashboard may be illuminated. This warns the driver if the fuel cap or charging socket cap remains open after filling the fuel tank or charging the battery. This improves driving safety as driving with an open cap may lead to safety issues and potential injury (e.g., fuel leakage, contact with an open cap) or vehicle damage.

Further, the vehicle 10 includes a rear lighting system at the rear portion of the vehicle 10 that includes brake lights that illuminate based on the driver activating a braking system of the vehicle and one or more running lights 24. The running lights 24 may be incorporated as part of a taillight assembly or utilize the same light sources as the brake lights, where the light sources are illuminated at a greater intensity when activated by the braking system of the vehicle as compared to when the light sources are illuminated as running lights. Optionally, the running lights 24 include a third brake light or center high mounted stop light (CHMSL) 26 of the vehicle 10.

The system 12 activates the running lights 24 based on determination of an environmental condition, such as based on detecting rain or based on determined ambient light levels at the vehicle 10 being below a threshold light level. Thus, the running lights 24 are illuminated during dark or rainy conditions to improve visibility of the vehicle 10 for other drivers behind the vehicle. The system 12 may receive sensor data and/or signals from one or more sensors or other systems of the vehicle, such as a rain sensor, ambient light sensor, one or more cameras of a vehicular vision system, and the like, to determine whether to activate the rear running lights 24.

That is, the system may provide automatic back light or reverse light activation. The system may automatically turn on the rear lights of the vehicle (e.g., the taillights and/or reversing lights) based on current weather conditions (e.g., fog or rain or low ambient light levels). The system may connect a back light ECU with a rain sensor or to an automatic headlight ECU. When the rain sensors detect that it is raining, the rear lights of the vehicle are turned on. When the automatic headlight system activates the front head lamps of the vehicle, the same input may activate the rear lights. Thus, the driver may activate automatic rear light operation by activating the automatic headlight mode of the vehicle. This improves vehicle safety as the vehicle may be more easily seen by other drivers during rainy or dark weather conditions.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the system may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340;US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may utilize sensors, such as radar sensors or imaging radar sensors or lidar sensors or the like, to detect presence of and/or range to objects (e.g., the vehicle license plate) and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controlling at least one function or feature of the vehicle (such as to provide autonomous driving control of the vehicle) responsive to processing of the data captured by the radar sensors.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular sensing system, the vehicular sensing system comprising:
a sensor disposed at a vehicle equipped with the vehicular sensing system;
an electronic control unit (ECU);
wherein sensor data captured by the sensor is transferred to the ECU;
wherein the ECU comprises electronic circuitry and associated software;
wherein the electronic circuitry of the ECU comprises a data processor operable to process sensor data captured by the sensor and transferred to the ECU;
wherein the vehicular sensing system is operable, at least in part via processing at the ECU of sensor data captured by the sensor, to determine whether a license plate is mounted at a license plate mounting region of the vehicle; and
wherein, responsive to determining, at least in part via processing at the ECU of sensor data captured by the sensor, that no license plate is mounted at the license plate mounting region, the vehicular sensing system generates an alert for a driver of the vehicle.

2. The vehicular sensing system of claim 1, wherein the sensor comprises a proximity sensor, and wherein a field of sensing of the proximity sensor includes the license plate mounting region, and wherein the vehicular sensing system determines that the license plate is mounted at the license plate mounting region based on detecting, at least in part via processing at the ECU of sensor data captured by the proximity sensor, an object at a distance from the proximity sensor that is less than a threshold distance.

3. The vehicular sensing system of claim 1, wherein the sensor comprises a contact sensor disposed at the license plate mounting region, and wherein the vehicular sensing system determines that the license plate is mounted at the license plate mounting region based on detecting, at least in part via processing at the ECU of sensor data captured by the sensor, an object that contacts the sensor at the license plate mounting region.

4. The vehicular sensing system of claim 1, wherein the sensor comprises a pressure sensor, and wherein the vehicular sensing system determines that the license plate is mounted at the license plate mounting region based on determining, at least in part via processing at the ECU of sensor data captured by the sensor, pressure at the pressure sensor that is greater than a threshold level, and wherein the vehicular sensing system determines that no license plate is mounted at the license plate mounting region based on determining, at least in part via processing at the ECU of sensor data captured by the sensor, pressure at the pressure sensor that is less than the threshold level.

5. The vehicular sensing system of claim 1, wherein the license plate comprises a short-range wireless communication device, and wherein the vehicular sensing system determines that the license plate is mounted at the license plate mounting region based at least in part on a signal received from the short-range wireless communication device of the license plate.

6. The vehicular sensing system of claim 5, wherein the signal comprises an identification signal representative of a registration number associated with the license plate, and wherein the vehicular sensing system determines that the license plate is mounted at the license plate mounting region based at least in part on determination that the registration number corresponds to the vehicle.

7. The vehicular sensing system of claim 6, wherein a plurality of registration numbers correspond to the vehicle, and wherein the vehicular sensing system determines that the license plate is mounted at the license plate mounting region based at least in part on determination that the registration number corresponds to one of the plurality of registration numbers corresponding to the vehicle.

8. The vehicular sensing system of claim 6, wherein the vehicular sensing system determines that no license plate is mounted at the license plate mounting region based at least in part on determination that the registration number does not correspond to the vehicle.

9. The vehicular sensing system of claim 1, wherein, based on determination that no license plate is mounted at the license plate mounting region, the vehicular sensing system limits operation of the vehicle.

10. The vehicular sensing system of claim 1, wherein the vehicle comprises a charge port connector configured to receive a charging wand for charging a battery system of the vehicle, and wherein the vehicle comprises a cover panel that is movable between (i) a closed position where the cover panel conceals the charge port connector and (ii) an opened position where the cover panel is moved away from the charge port connector to provide access to the charge port connector.

11. The vehicular sensing system of claim 10, wherein, based on determination that the cover panel is in the opened position, and based on determination that the driver is attempting to operate the vehicle, the vehicular sensing system generates another alert for the driver of the vehicle.

12. The vehicular sensing system of claim 10, wherein, based on determination that the cover panel is in the opened position, the vehicular sensing system limits operation of the vehicle.

13. The vehicular sensing system of claim 1, wherein, based on determination of an environmental condition, the vehicular sensing system operates a rear lighting module of the vehicle to emit light rearward of the vehicle, and wherein the determined environmental condition comprises at least one selected from the group consisting of (i) rain at the vehicle and (ii) an ambient light level at the vehicle less than a threshold light level.

14. The vehicular sensing system of claim 13, wherein the rear lighting module comprises at least one selected from the group consisting of (i) a running light, (ii) a taillamp, and (iii) a center high mounted stop light.

15. A vehicular sensing system, the vehicular sensing system comprising:
a contact sensor disposed at a license plate mounting region of a vehicle equipped with the vehicular sensing system;
an electronic control unit (ECU);
wherein sensor data captured by the contact sensor is transferred to the ECU;
wherein the ECU comprises electronic circuitry and associated software;
wherein the electronic circuitry of the ECU comprises a data processor operable to process sensor data captured by the contact sensor and transferred to the ECU;
wherein the vehicular sensing system is operable, at least in part via processing at the ECU of sensor data captured by the contact sensor, to determine whether a license plate is mounted at the license plate mounting region, and wherein the vehicular sensing system determines that the license plate is mounted at the license plate mounting region based on detecting, at least in part via processing at the ECU of sensor data captured by the contact sensor, an object that contacts the sensor at the license plate mounting region; and
wherein, responsive to determining, at least in part via processing at the ECU of sensor data captured by the contact sensor, that no license plate is mounted at the license plate mounting region, the vehicular sensing system (i) generates an alert for a driver of the vehicle and (ii) limits operation of the vehicle.

16. The vehicular sensing system of claim 14, wherein the license plate comprises a short-range wireless communication device, and wherein the vehicular sensing system receives a signal from the short-range wireless communication device of the license plate, and wherein the signal comprises an identification signal representative of a registration number associated with the license plate, and wherein the vehicular sensing system determines that the license plate is mounted at the license plate mounting region based at least in part on determination that the registration number corresponds to the vehicle.

17. The vehicular sensing system of claim 16, wherein a plurality of registration numbers correspond to the vehicle, and wherein the vehicular sensing system determines that the license plate is mounted at the license plate mounting region based at least in part on determination that the registration number corresponds to one of the plurality of registration numbers corresponding to the vehicle.

18. The vehicular sensing system of claim 16, wherein the vehicular sensing system determines that no license plate is mounted at the license plate mounting region based at least in part on determination that the registration number does not correspond to the vehicle.

19. A vehicular sensing system, the vehicular sensing system comprising:
a proximity sensor disposed at a vehicle equipped with the vehicular sensing system, wherein a field of sensing of the proximity sensor includes a license plate mounting region of the vehicle;
an electronic control unit (ECU);
wherein sensor data captured by the proximity sensor is transferred to the ECU;
wherein the ECU comprises electronic circuitry and associated software;
wherein the electronic circuitry of the ECU comprises a data processor operable to process sensor data captured by the proximity sensor and transferred to the ECU;
wherein the vehicular sensing system is operable, at least in part via processing at the ECU of sensor data captured by the proximity sensor, to determine whether a license plate is mounted at the license plate mounting region, and wherein the vehicular sensing system determines that the license plate is mounted at the license plate mounting region based on detecting, at least in part via processing at the ECU of sensor data captured by the proximity sensor, an object at a distance from the proximity sensor that is less than a threshold distance; and
wherein, responsive to determining, at least in part via processing at the ECU of sensor data captured by the proximity sensor, that no license plate is mounted at the license plate mounting region, the vehicular sensing system (i) generates an alert for a driver of the vehicle and (ii) limits operation of the vehicle.

20. The vehicular sensing system of claim 19, wherein the license plate comprises a short-range wireless communication device, and wherein the vehicular sensing system receives a signal from the short-range wireless communication device of the license plate, and wherein the signal comprises an identification signal representative of a registration number associated with the license plate, and wherein the vehicular sensing system determines that the license plate is mounted at the license plate mounting region based at least in part on determination that the registration number corresponds to the vehicle, and wherein the vehicular sensing system determines that no license plate is mounted at the license plate mounting region based at least in part on determination that the registration number does not correspond to the vehicle.
